(19) United States
(12) Patent Application Publication
(10) Pub. No.: US 2024/0128796 A1
(43) Pub. Date: Apr. 18, 2024

(54) CAPACITIVE POWER TRANSFER SYSTEM FOR VEHICLE AND OPERATING METHOD THEREOF

(71) Applicants: Hyundai Motor Company, Seoul (KR); Kia Corporation, Seoul (KR); SEOUL NATIONAL UNIVERSITY R&DB FOUNDATION, Seoul (KR)

(72) Inventors: Eui Hoon Chung, Hwaseong (KR); Gyu Yeong Choe, Hwaseong (KR); Young Jin Kim, Hwaseong (KR); Sung Hyuk Choi, Seoul (KR); Jung Ik Ha, Seoul (KR)

(21) Appl. No.: 18/482,080

(22) Filed: Oct. 6, 2023

(30) Foreign Application Priority Data
Oct. 7, 2022 (KR) 10-2022-0128869

(51) Int. Cl. H02J 50/05; B60L 53/14; H02J 50/90

(52) U.S. Cl. CPC H02J 50/05; B60L 53/14; H02J 50/90

(57) ABSTRACT

A power transfer system includes an electric vehicle supply equipment (EVSE) for providing electric power to an electric vehicle (EV) and an electric power reception device mounted in the EV; a first conductor plate electrically connected to a primary-side circuit of the EVSE; a compensation circuit for transferring a power input signal of the EVSE to the first conductor plate; a second conductor plate disposed in the EV and connected to the electric power reception device; and a secondary-side circuit for transferring a power signal received by the second conductor plate to a load, where the electric power is transferred from the EVSE to the EV by capacitive coupling between the first conductor plate and the second conductor plate.

### CROSS-REFERENCE TO RELATED APPLICATION

This application claims under 35 U.S.C. § 119(a) the benefit of Korean Patent Application No. 10-2022-0128869, filed on Oct. 7, 2022 with the Korean Intellectual Property Office (KIPO), the entire contents of which are hereby incorporated by reference.

### BACKGROUND

### 1. Technical Field

The present disclosure relates to a capacitive power transfer system for wireless power transfer to a vehicle, more particularly, to a power transfer system, power transfer device, and operation methods thereof, which are designed to be tolerant of a variation in capacitive coupling between two plates forming a capacitance.

### 2. Description of the Related Art

An electric vehicle (EV) is powered by a motor with battery power and offers advantages such as reduced air pollution, reduced exhaust gases and noises, fewer breakdowns, longer lifespan, and simplified operation as compared to a conventional gasoline engine vehicle.

EVs may be classified into hybrid electric vehicles (HEVs), plug-in hybrid electric vehicles (PHEVs), and electric vehicles (EVs) based on their power sources or propulsion systems. The HEV has an engine for main power and a motor for auxiliary power, while the PHEV has a motor for main power and an engine that is used when a battery is discharged. The EV, on the other hand, is powered solely by a motor and does not have an engine.

In general, wireless power transfer (WPT) to an EV may be performed by a transmission unit, which includes a transmission pad installed outside the EV, and a reception unit, which includes a reception pad installed inside the EV. The transmission unit converts energy supplied from a power grid into a high-frequency alternating current (AC) signal through a switching device, and transfers it to the transmission pad. A voltage is induced in the reception pad by a time-varying magnetic field generated in the transmission pad. A power conversion circuit mounted in the reception unit converts power received through the reception pad into a direct current (DC) voltage to charge a high voltage battery. In this case, the size and efficiency of wirelessly transmitted power may vary depending on an alignment between the transmission pad and the reception pad.

### SUMMARY

An objective of the present disclosure is to reduce a weight of a complex circuitry of a receiver (i.e., vehicle-mounted part) for compensating for misalignment between a transmission pad and a reception pad in wireless power transfer (WPT), and to reduce a size, thickness, weight, and cost associated with the circuitry.

Another objective of the present disclosure is to provide an electric vehicle charging system, device, and operation method using capacitive coupling, which overcome limitations of mountability due to the increased size, thickness, and weight of the vehicle-mounted part caused by a resonant pad made of a multi-layer structure of coils/cores in conventional inductive-type WPT.

Another objective of the present disclosure is to propose a parameter determination process of a compensation circuit of an electric vehicle power transfer system and device designed to have tolerant characteristics against variations in capacitive coupling due to misalignment or changes in air gap between transmission and reception pads.

Another objective of the present disclosure is to propose a power transfer system, device, and operation method that have tolerant characteristics against output voltage fluctuation and misalignment between transmission and reception pads.

A power transfer system according to a first exemplary embodiment of the present disclosure may be a power transfer system including an electric vehicle supply equipment (EVSE) for providing electric power to an electric vehicle (EV) and an electric power reception device mounted in the EV. The power transfer system may comprise: a first conductor plate electrically connected to a primary-side circuit of the EVSE; a compensation circuit for transferring a power input signal of the EVSE to the first conductor plate; a second conductor plate disposed in the EV and connected to the electric power reception device; and a secondary-side circuit for transferring a power signal received by the second conductor plate to a load, wherein the electric power is transferred from the EVSE to the EV by capacitive coupling between the first conductor plate and the second conductor plate.

The compensation circuit may have parameters determined based on a tolerance range of a variation in the capacitive coupling.

The parameters of the compensation circuit may be determined using an equivalent circuit analysis technique derived under a condition that a compensation operation corresponding to the tolerance range of the variation in the capacitive coupling is entirely performed by the primary-side circuit.

The parameters of the compensation circuit may be determined using a T-type 2-port equivalent circuit analysis technique for the compensation circuit.

The parameters of the compensation circuit may be determined using an equivalent circuit analysis technique assuming a plurality of operating frequency candidate groups for the compensation circuit.

The tolerance range of the variation in the capacitive coupling may be determined based on at least one of a tolerance range of a variation in a gap and a tolerance range of a misalignment between the first conductor plate and the second conductor plate.

The tolerance range of the variation in the capacitive coupling may be determined based on assumption for at least one of: a maximum allowable voltage between the first conductor plate and the second conductor plate; an allowable range of a capacitance formed by the capacitive coupling; a size of the first conductor plate and the second conductor plate; a tolerance range of a variation in a gap between the first conductor plate and the second conductor plate; or a tolerance range of a misalignment between the first conductor plate and the second conductor plate.

An operating range of a frequency of the power input signal may be controlled based on a result of detecting a variation in the capacitive coupling.

A power transfer device according to a second exemplary embodiment of the present disclosure may be a power transfer device disposed in an EVSE for providing electric power to an EV. The power transfer device may comprise: a first conductor plate; and a compensation circuit for transferring a power input signal of the EVSE to the first conductor plate, wherein the electric power is transferred from the EVSE to the EV by capacitive coupling between the first conductor plate and a second conductor plate electrically connected to a secondary-side circuit of the EV.

An electric vehicle may include an electric power reception device for (wirelessly) receiving electric power from the power transfer device.

The compensation circuit may have parameters determined based on a tolerance range of a variation in the capacitive coupling.

The parameters of the compensation circuit may be determined using an equivalent circuit analysis technique derived under a condition that a compensation operation corresponding to the tolerance range of the variation in the capacitive coupling is entirely performed by the compensation circuit.

The parameters of the compensation circuit may be determined using a T-type 2-port equivalent circuit analysis technique for the compensation circuit.

The parameters of the compensation circuit may be determined using an equivalent circuit analysis technique assuming a plurality of operating frequency candidate group for the compensation circuit.

The tolerance range of the variation in the capacitive coupling may be determined by at least one of a tolerance range of a variation in a gap and a tolerance range of a misalignment between the first conductor plate and the second conductor plate.

The tolerance range of the variation in the capacitive coupling may be determined based on assumption for at least one of: a maximum allowable voltage between the first conductor plate and the second conductor plate; an allowable range of a capacitance formed by the capacitive coupling; a size of the first conductor plate and the second conductor plate; a tolerance range of a variation in a gap between the first conductor plate and the second conductor plate; or a tolerance range of a misalignment between the first conductor plate and the second conductor plate.

An operating range of a frequency of the power input signal may be controlled based on a result of detecting a variation in the capacitive coupling.

An operation method of a power transfer device according to a third exemplary embodiment of the present disclosure may be an operation method of a power transfer device disposed in an EVSE for providing electric power to an EV. The operation method may comprise: operating so that a secondary-side alternating current (AC) signal is induced on a second conductor plate connected to the EV based on a variation in an electric field due to a primary-side AC signal applied to a first conductor plate connected to the EVSE; detecting a variation in capacitive coupling between the first conductor plate and the second conductor plate; and controlling a frequency of the primary-side AC signal based on the variation in the capacitance coupling.

In the controlling of the frequency of the primary-side AC signal, the frequency of the primary-side AC signal may be controlled within a target range.

The detecting of the variation in the capacitive coupling may comprise: measuring state variable(s) of at least one of the primary-side AC signal and the secondary-side AC signal, wherein the state variable(s) may include at least one of voltage, current, frequency, phase, power, and efficiency.

The variation in the capacitive coupling may be formed by at least one of a variation in a gap or a misalignment between the first conductor plate and the second conductor plate. system.

### BRIEF DESCRIPTION OF DRAWINGS

FIG. 1 is a conceptual diagram of an example of a wireless power transfer (WPT)

FIGS. 2 to 5 are conceptual diagrams illustrating exemplary embodiments of an Autoconnect Charging Device (ACD) for power transfer.

FIG. 6 is a conceptual diagram of a power transfer system and/or device using capacitive coupling according to an exemplary embodiment of the present disclosure.

FIG. 7 is a conceptual diagram illustrating a power transfer device and/or system according to an exemplary embodiment of the present disclosure.

FIG. 8 is a conceptual diagram illustrating an equivalent circuit-based analysis process for determining parameters of the compensation circuit 252 of the power transfer device according to an exemplary embodiment of the present disclosure.

FIG. 9 is a conceptual diagram illustrating a T-type 2-port network equivalent circuit-based analysis process for determining parameters of the compensation circuit 252 of the power transfer device according to an exemplary embodiment of the present disclosure.

FIG. 10 is a diagram illustrating a single frequency-based impedance analysis process for determining parameters of the compensation circuit of the power transfer device according to an exemplary embodiment of the present disclosure.

FIG. 11 is a diagram illustrating a 2-frequency based impedance analysis process for determining parameters of the compensation circuit of the power transfer device according to an exemplary embodiment of the present disclosure.

FIG. 12 is a diagram illustrating the primary-side circuit of the power transfer device including the compensation circuit whose parameters are determined according to an exemplary embodiment of the present disclosure.

FIG. 13 is a diagram illustrating a parameter determination process of the primary-side compensation circuit of the power transfer device according to an exemplary embodiment of the present disclosure.

FIG. 14 is a diagram illustrating a parameter determination process of the primary-side compensation circuit of the power transfer device according to an exemplary embodiment of the present disclosure.

FIG. 15 is a diagram illustrating an operation method of the power transfer device tolerant of coupling variation according to an exemplary embodiment of the present disclosure.

FIG. 16 is an operational flowchart illustrating an operation method of the power transfer device tolerant of coupling variation according to an exemplary embodiment of the present disclosure.

FIG. 17 is a diagram illustrating a process of determining a capacitance in consideration of a breakdown voltage related to a process of determining parameters of the primary-side compensation circuit of the power transfer device according to an exemplary embodiment of the present disclosure.

FIG. 18 is a diagram illustrating a process of determining the size of the conductor plate related to a process of determining capacitance according to an exemplary embodiment of the present disclosure.

FIG. 19 is a diagram illustrating a relationship between a size of a conductor plate and a capacitance related to a process of determining parameters of the power transfer device according to an exemplary embodiment of the present disclosure.

FIG. 20 is a diagram illustrating a relationship between a size of a conductor plate, coupling variation, and capacitance related to a process of determining parameters of the power transfer device according to an exemplary embodiment of the present disclosure.

FIG. 21 is a conceptual diagram illustrating an example of a generalized wireless power transfer apparatus, wireless power transfer system, or computing system for controlling wireless power transfer procedure.

It may be understood that the appended drawings are not necessarily to scale, presenting a somewhat simplified representation of various features illustrative of the basic principles of the present disclosure. The predetermined design features of the present disclosure as disclosed herein, including, for example, predetermined dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION OF THE EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Exemplary embodiments of the present disclosure are disclosed herein. However, specific structural and functional details disclosed herein are merely representative for purposes of describing exemplary embodiments of the present disclosure. Thus, exemplary embodiments of the present disclosure may be embodied in many alternate forms and should not be construed as limited to exemplary embodiments of the present disclosure set forth herein.

Accordingly, while the present disclosure is capable of various modifications and alternative forms, specific exemplary embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

Terms used in the present disclosure may be defined as follows.

“Electric Vehicle (EV)”: An automobile, as defined in 49 CFR 523.3, intended for highway use, powered by an electric motor that draws current from an on-vehicle energy storage device, such as a battery, which is rechargeable from an off-vehicle source, such as residential or public electric service or an on-vehicle fuel powered generator. The EV may be a four or more wheeled vehicle manufactured for use primarily on public streets or roads.

The EV may include an electric vehicle, an electric automobile, an electric road vehicle (ERV), a plug-in vehicle (PV), a plug-in vehicle (xEV), etc., and the xEV may be classified into a plug-in all-electric vehicle, a battery electric vehicle (BEV), a plug-in electric vehicle (PEV), a hybrid electric vehicle (HEV), a hybrid plug-in electric vehicle (HPEV), a plug-in hybrid electric vehicle (PHEV), etc.

“Plug-in Electric Vehicle (PEV)”: An Electric Vehicle that recharges the on-vehicle primary battery by connecting to the power grid.

“Plug-in vehicle (PV)”: An electric vehicle rechargeable via wireless charging from an electric vehicle supply equipment (EVSE) without using a physical plug or a physical socket.

“Heavy duty vehicle (H.D. Vehicle)”: Any four-or more wheeled vehicle as defined in 49 CFR 523.6 or 49 CFR 37.3 (bus).

“Light duty plug-in electric vehicle”: A three or four-wheeled vehicle propelled by an electric motor drawing current from a rechargeable storage battery or other energy devices for use primarily on public streets, roads and highways and rated at less than 4,545 kg gross vehicle weight.

“Wireless power charging system (WCS)”: A system for wireless power transfer and control of interactions including operations for an alignment and communications between a ground assembly (GA) and a vehicle assembly (VA) or between a primary device and a secondary device.

“Wireless power transfer (WPT)”: A transfer of electric power from a power source such as a utility, the power grid, an energy storage device, a fuel cell generator through a contactless channel such as electromagnetic induction and resonance to the EV or a transfer of the electric power from the EV to a power source.

“Utility”: A set of systems which supply electrical energy and include a customer information system (CIS), an advanced metering infrastructure (AMI), rates and revenue system, etc. The utility may provide an EV with energy through rates table and discrete events. Also, the utility may provide information related to certification on EVs, interval of power consumption measurements, and tariff.

“Smart charging”: A system in which EVSE and/or EV (including the PEV, or PHEV) communicate with power grid to optimize charging ratio or discharging ratio of EV by reflecting capacity of the power grid or expense of use.

“Automatic charging”: A procedure in which inductive charging is automatically performed after a vehicle is located in a proper position corresponding to a primary charger assembly which may transfer power. The automatic charging may be performed after obtaining necessary authentication and right.

“Interoperability”: A state in which components of a system interwork with corresponding components of the system to perform operations aimed by the system. Additionally, information interoperability may refer to capability that two or more networks, systems, devices, applications, or components may efficiently share and easily use information without causing inconvenience to users.

“Inductive charging system”: A system transferring energy from a power source to an EV via a two-part gapped core transformer in which the two halves of the transformer, i.e., primary and secondary coils, are physically separated from one another. In the present disclosure, the inductive charging system may correspond to an EV power transfer system.

“Inductive coupler”: The transformer formed by the primary coil in the primary device or GA and the secondary coil in the secondary device or VA that allows power to be transferred through electric isolation.

“Inductive coupling”: A magnetic coupling between two coils. One of the two coils may refer to a primary coil or ground assembly (GA) coil, and the other one of the two coils may refer to a secondary coil or vehicle assembly (VA) coil.

“Supply Power Circuit (SPC) or “Ground assembly (GA)”: An assembly on the infrastructure side including the primary coil (or GA Coil), a power/frequency conversion unit and SPC controller (or GA controller) as well as the wiring from the grid and between each unit, filtering circuits, at least one housing, etc., necessary to function as the power source of a wireless power charging system. The SPC or GA may include at least one part to control the impedance and resonant frequency, the ferrite enforcing the magnetic path, and/or electromagnetic shielding materials. The SPC or GA may include the communication elements necessary for communication between the primary device (or GA) and the secondary device (or VA).

“EV power circuit (EVPC)” or “Vehicle assembly (VA)”: An assembly on the vehicle including the primary coil (or VA Coil), rectifier/power conversion unit and EVPC controller (or VA controller) as well as the wiring to the vehicle batteries and between each unit, filtering circuits, at least one housing, etc., necessary to function as the vehicle part of a wireless power charging system. The EVPC or VA may include at least one part to control the impedance and resonant frequency, the ferrite enforcing the magnetic path, and/or electromagnetic shielding materials. The EVPC or VA may include the communication elements necessary for communication between the primary device (or GA) and the secondary device (or VA).

The SPC may be referred to as a primary device (PD), or a GA, or the like, and the EVPC may be referred to as a secondary device (SD), or a VA, or the like.

The GA may be referred to as a supply device, a power supply side device, or the like, and the VA may be referred to as an EV device, an EV side device, or the like.

“Primary device”: An apparatus which provides the contactless coupling to the secondary device. In other words, the primary device may be an apparatus external to an EV. When the EV is receiving power, the primary device may operate as the source of the power to be transferred. The primary device may include the housing and all covers.

“Secondary device”: An apparatus mounted on the EV which provides the contactless coupling to the primary device. In other words, the secondary device may be provided within the EV. When the EV is receiving power, the secondary device may transfer the power from the primary battery to the EV. The secondary device may include the housing and all covers.

“Supply Power Electronics”: The portion of the SPC or GA which regulates the output power level to the primary coil (or GA Coil) based on information from the vehicle.

“EV Power Electronics”: The portion of the EVPC or VA that monitors specific on-vehicle parameters during charging and initiates communication with the EVPC or GA to adjust an output power level.

The Supply Power Electronics may be referred to as a GA electronics, or GA controller, or primary device communication controller (PDCC), and the EV Power Electronics may be referred to as a VA electronics, or VA controller, or electric vehicle communication controller (EVCC).

“Magnetic gap”: The vertical distance between the plane of the higher of the top of the litz wire or the top of the magnetic material in the primary coil/GA Coil to the plane of the lower of the bottom of the litz wire or the magnetic material in the secondary coil/VA Coil when aligned.

“Ambient temperature”: The ground-level temperature of the air measured at the subsystem under consideration and not in direct sun light.

“Vehicle ground clearance”: The vertical distance between the ground surface and the lowest part of the vehicle floor pan.

“Vehicle magnetic ground clearance”: The vertical distance between the plane of the lower of the bottom of the litz wire or the magnetic material in the secondary coil/VA Coil mounted on a vehicle to the ground surface.

“Secondary coil surface distance” or “VA coil magnetic surface distance”: the distance between the plane of the nearest magnetic or conducting component surface to the lower external surface of the secondary coil/VA coil when mounted. The present distance includes any protective coverings and additional items which may be packaged in the secondary coil/VA coil enclosure.

The secondary coil may be referred to as a VA coil, a vehicle coil, or a receiver coil. Similarly, the primary coil may be referred to as a GA coil, or a transmit coil.

“Exposed conductive component”: A conductive component of electrical equipment (e.g., an electric vehicle) which may be touched and which is not normally energized but which may become energized when a fault occurs.

“Hazardous live component”: A live component, which under certain conditions may generate a harmful electric shock.

“Live component”: Any conductor or conductive component intended to be electrically energized in normal use.

“Direct contact”: Contact of persons with live components. (See, IEC 61440.)

“Indirect contact”: Contact of persons with exposed, conductive, and energized components made live by an insulation failure. (See, IEC 61140.)

“Alignment”: A process of finding the relative position of primary device (supply device) to secondary device (EV device) and/or finding the relative position of primary device/supply device to secondary device/EV device for the efficient power transfer which is specified. In the present disclosure, the alignment may direct to a fine positioning of the wireless power transfer system does not limit to a specific embodiment.

“Pairing”: A process by which a vehicle (EV) is correlated with a dedicated supply device (primary device), at which the vehicle is located and from which the power will be transferred. Pairing may include the process by which a SPC/GA controller of a charging spot and an EVPC/VA controller are correlated.

The correlation/association process may include the process of association or establishment of a relationship between two peer communication entities.

Command and control communication may refer to communication between an electric vehicle power supply equipment and electric vehicle exchanging information necessary for starting, controlling, and ending a wireless power transfer process.

“High-level communication (HLC)”: HLC is a special type of digital communication. HLC is necessary for additional services which are not covered by command and control communication. The data link of the HLC may use a power line communication (PLC), but the data link of the HLC is not limited to the PLC.

“Low-power excitation (LPE)”: LPE refers to a technique of activating the supply device (or primary device) for the fine positioning and pairing so that the EV may detect the supply device, and vice versa.

“Service set identifier (SSID)”: SSID is a unique identifier including 32-characters attached to a header of a packet transmitted on a wireless LAN. The SSID identifies the basic service set (BSS) to which the wireless device attempts to connect. The SSID distinguishes multiple wireless LANs. Therefore, all access points (APs) and all terminal/station devices that want to use a specific wireless LAN may use the same SSID. Devices that do not use a unique SSID are not able to join the BSS. Because the SSID is shown as plain text, the SSID may not provide any security features to the network.

“Extended service set identifier (ESSID)”: ESSID is the name of the network to which one desires to connect. ESSID is similar to SSID but a more extended concept.

“Basic service set identifier (BSSID)”: BSSID including 48bits is used to distinguish a specific BSS. With an infrastructure BSS network, the BSSID may be configured for medium access control (MAC) of the AP equipment. For an independent BSS or Ad-hoc network, the BSSID may be generated with any value.

The charging station may include at least one GA and at least one GA controller configured to manage the at least one GA. The GA may include at least one wireless communication device. The charging station may refer to a place or location including at least one GA, which is provided in home, office, public place, road, parking area, etc.

In the present specification, ‘association’ may be used as a term to denote a procedure for establishing wireless communication between the electric vehicle communication controller (EVCC) and the supply equipment communication controller (SECC) controlling the charging infrastructure. Hereinafter, exemplary embodiments of the present disclosure will be described in detail with reference to the accompanying drawings.

Even technologies known prior to the filing date of the present application may be included as a part of the configuration of the present disclosure as necessary and are described herein within a range that does not obscure the spirit of the present disclosure. However, in the following description of the configuration of the present disclosure, matters of technologies that are known prior to the filing date of the present application and that are obvious to those of ordinary skill in the art are not described in detail when it is determined that they would obscure the present disclosure due to unnecessary detail.

However, the present disclosure is not intended to claim rights to the known technologies, and the contents of the known technologies may be incorporated as part of the present disclosure without departing from the spirit of the present disclosure.

Hereinafter, embodiments of the present disclosure will be described in more detail with reference to the accompanying drawings. In describing the present disclosure, in order to facilitate an overall understanding thereof, the same components are assigned the same reference numerals in the drawings and are not redundantly described herein.

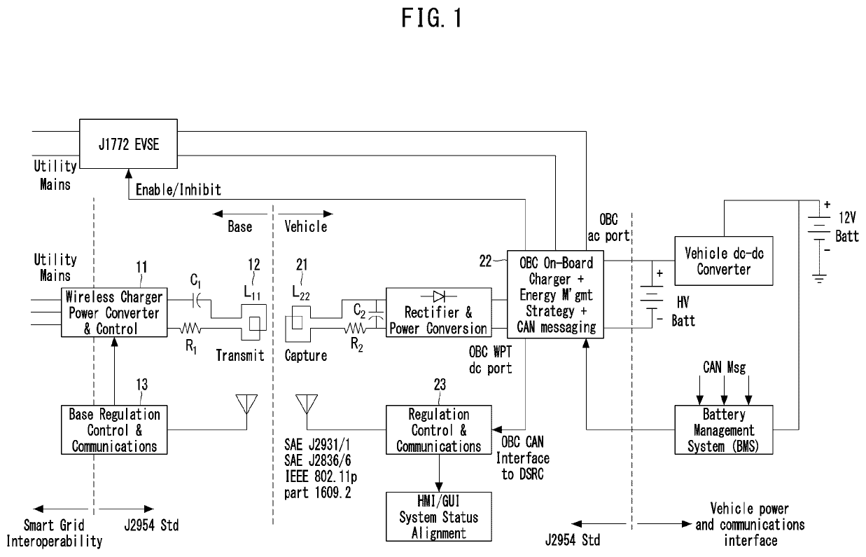

FIG. 1 is a conceptual diagram of an example of a wireless power transfer (WPT) system.

As shown in FIG. 1, an EV charging system may include a conductive charging system using a cable or a non-contact wireless power transfer (WPT) system, but is not limited thereto. The EV charging system may be basically defined as a system that charges a battery mounted in an EV using power from a commercial power grid or an energy storage device. The EV charging system may have various forms depending on the type of EV.

As a leading standard for wireless charging, the SAE TIR J2954 establishes industry-standard specification guidelines that define acceptance criteria for interoperability, electromagnetic compatibility, minimum performance, safety, and testing for wireless charging of light-duty electric and plug-in electric vehicles.

Referring to FIG. 1 illustrating an example of a wireless charging system, a wireless communication system (WCS) according to the J2954 standard may comprise a utility interface, high-frequency power inverter, coupling coils, rectifier, filter, optional regulator, and communications between a vehicle energy charging/storage system and a power inverter connected to a utility. The utility interface may be similar to a conventional EVSE connection to a single-phase or three-phase AC power.

The wireless charging systems for EVs may be largely classified into the following three types.
1) GA coil 12 for power connection, grid-connected power converter 11, and communication link 13 with a vehicle system
2) VA coil 21 with rectification and filtering components, charging control power electronics 22 for regulation/safety/shutdown if necessary, and communication link 23 with a base station side
3) Secondary energy storage system, battery management system components, and related modules required for in-vehicle communication (e.g., CAN, LIN, etc.) required for a battery state of charge (SOC), charge rate, and other necessary information

In general, when charging an EV, the EV may enter a charging station, connect with a charger to be charged using wireless LAN (WLAN) communication such as the IEEE 802.11n, and then proceed with charging.

The WPT system of FIG. 1 is generally known to use inductive coupling, but in a power transfer system according to an exemplary embodiment of the present disclosure, a transmission pad and a reception pad may be configured as conductive plates. Further, a configuration in which power is transferred by capacitive coupling may be adopted on the premise of an environment in which a gap between the transmission pad and the reception pad is controlled within a predetermined range. In this case, the configuration of FIG. 1 may be used within a scope corresponding to the objective of the present disclosure, and may be selectively used or appropriately modified as necessary.

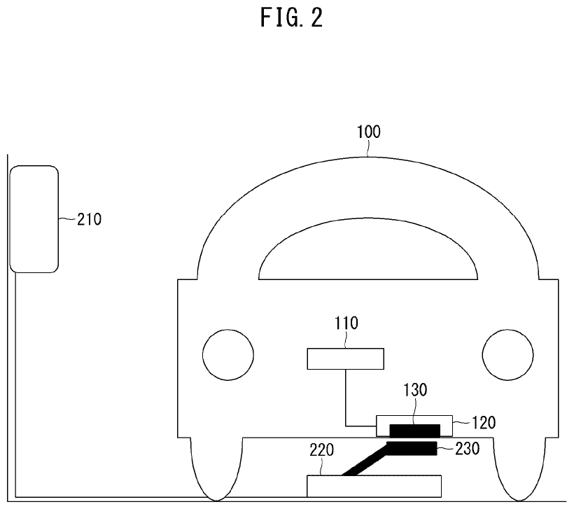

FIGS. 2 to 5 are conceptual diagrams illustrating exemplary embodiments of an Autoconnect Charging Device (ACD) for power transfer.

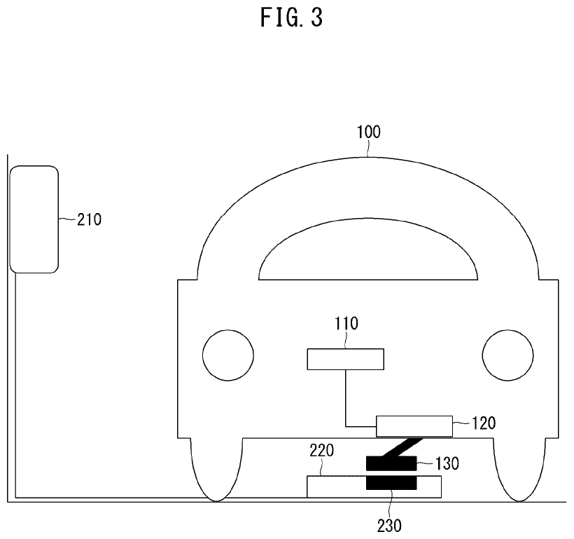

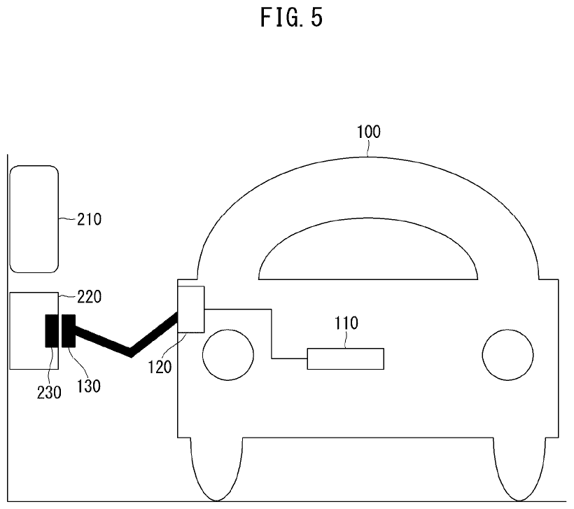

The ISO15118-8, an international standard related to EV charging wireless communication, allows an EV to be connected to a charger AP other than a general AP through a Vendor Specific Element (VSE) field of a MAC frame, which corresponds to the second layer of OSI 7 layers. However, since information on positioning and pairing is not properly defined within the VSE field of the charger/SECC except for WPT, various positioning and communication techniques may be applied for precise positioning and paring in the ACD-based robot charging system such as ACD-underbody (ACD-U) type of FIGS. 2 to 3 or ACD-side (ACD-S) type of FIG. 5.

An on-board vehicle power supply circuit mounted in an EV 100 may include a battery 110 as a load. An ACD-VU 120 mounted in the EV 100 may receive power via a vehicle inlet 130 and transfer it to the battery 110.

An EV charging station 210 is illustrated as a part of an EVSE for supplying power to the EV 100. The charging station 210 may be electrically connected to an ACD station 220, and power may be transferred to the vehicle inlet 130 via a connector 230 of the ACD station 220.

The connector 230 and the vehicle inlet 130 may be brought into close proximity to form a coupling. In an exemplary embodiment of the present disclosure, the connector 230 and the vehicle inlet 130 may be controlled to be adjacent to each other so that capacitive coupling is formed therebetween.

Referring to FIGS. 2 and 3, exemplary embodiments of an ACD-U type EV wireless charging scheme are shown. The ACD station 220 is located below the EV 100, and this configuration may be collectively referred to as ‘ACD-U type’.

According to an exemplary embodiment, as shown in FIG. 2, the connector 230 may protrude from the station 220 and be controlled to approach the vehicle inlet 130. In this case, the connector 230 may be connected to and controlled by a robot arm.

According to an exemplary embodiment, as shown in FIG. 3, the vehicle inlet 130 may protrude from the ACD-VU 120 and be controlled to approach the connector 230. In this case, the vehicle inlet 130 may be connected to and controlled by a robot arm.

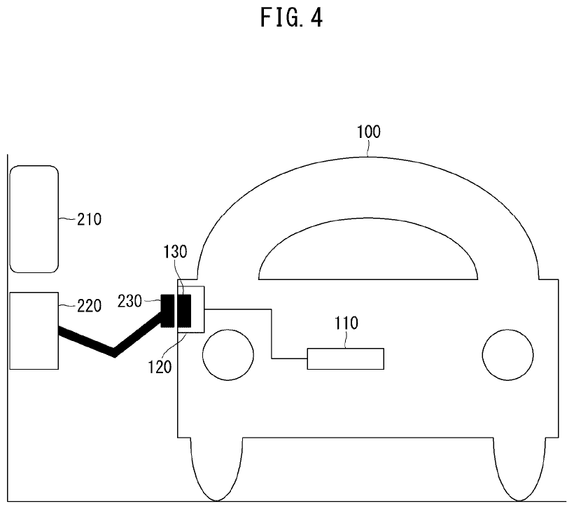

Referring to FIGS. 4 and 5, exemplary embodiments of an ACD-S type EV wireless charging scheme are shown. The ACD station 220 is located alongside the EV 100, and this configuration may be collectively referred to as ‘ACD-S type’.

According to an exemplary embodiment, as shown in FIG. 4, the connector 230 may protrude from the station 220 and be controlled to approach the vehicle inlet 130. In this case, the connector 230 may be connected to and controlled by a robot arm.

According to an exemplary embodiment, as shown in FIG. 5, the vehicle inlet 130 may protrude from the ACD-VU 120 and be controlled to approach the connector 230. In this case, the vehicle inlet 130 may be connected to and controlled by a robot arm.

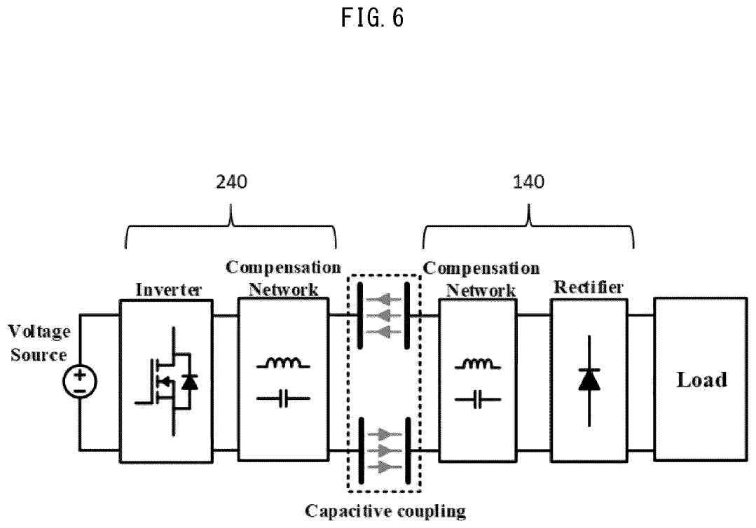

FIG. 6 is a conceptual diagram of a power transfer system and/or device using capacitive coupling according to an exemplary embodiment of the present disclosure.

As shown in FIG. 6, a primary-side circuit 240 disposed in the EVSE and a secondary-side circuit 250 mounted in the EV 100 are illustrated.

At an end portion of the primary-side circuit 240, there is a first conductor plate (pair) consisting of a pair of two conductive plates. At a front portion of the secondary-side circuit 250, there is a second conductor plate (pair) consisting of a pair of two conductive plates.

According to an exemplary embodiment of the present disclosure, a capacitive wireless charging system in which energy is wirelessly transmitted via a gap between the conductive plates may be provided. In this case, capacitive coupling may be formed between the conductive plates. An AC electric field may be formed between the conductive plates by a primary-side AC signal applied to the first conductor plate. A secondary-side AC signal may be induced in the second conductor plate by the AC electric field. Through the above-described process, an input voltage/current may be transferred to an output by the capacitive coupling between the conductive plates, and power may be transferred from input to output.

According to an exemplary embodiment of the present disclosure, when capacitive coupling between the conductive plates is used, the thickness of resonant pads may be reduced to several millimeters. Compared to the conventional indictive WPT system using pads having a multi-layer structure composed of coils/cores, an advantageous effect can be achieved for vehicle applications. The advantageous effect specifically means reduction of the size, thickness, weight and cost. In addition, an exemplary embodiment of the present disclosure has an advantage that it can be applied regardless of a vehicle ground clearance, and the size and thickness of a protruding part at the lower end of the EV 100 can be reduced, so that interference with a floor and impact while driving can be reduced.

The power transfer system according to an exemplary embodiment of the present disclosure may be a power transfer system including an EVSE that supplies power to an EV and a device (i.e., power reception device) disposed in the EV to receive power. The power transfer system may include a first conductor plate electrically connected to a primary-side circuit of the EVSE; a compensation circuit for transferring a power input signal of the EVSE to the first conductor plate; a second conductor plate disposed in the EV and connected to the power reception device; and a secondary-side circuit that transfers a power signal received by the second conductor plate to a load. In this case, power may be transferred from the EVSE to the EV by capacitive coupling between the first conductor plate and the second conductor plate.

It may be controlled to maintain a gap of several mm to several cm in order to generate high capacitance between the conductive plates that are the transmission/reception pads, and for this control, various available position control schemes, including a robot arm, may be used. Exemplary embodiments of such the position control schemes may be implemented by the above FIGS. 2 to 5. By adopting such the position control scheme, the user may reduce inconvenience during charging for position alignment.

A small gap (or airgap) between the conductor plates may improve power transfer capability and efficiency. It may also increase a power density of the WPT system. The capacitive coupling may be formed in the air gap between the conductor plates. In this case, it may be apparent to those skilled in the art that the conductor plate does not necessarily have to be a flat plate. For convenience of description, in the present specification, it will be referred to as a conductor plate or a conductive plate, but due to this, the spirit of the present disclosure should not be construed as being limited to specific exemplary embodiments.

By using a compensation network, it is possible to implement a WPT system that is tolerant of misalignment between the conductor plates. As a result, efficient WPT may be made possible using a simple position control system.

An automatic direct contact charging system and the WPT system may be combined, and even in this combination, convenience, which is an advantage of the present disclosure, may be maintained.

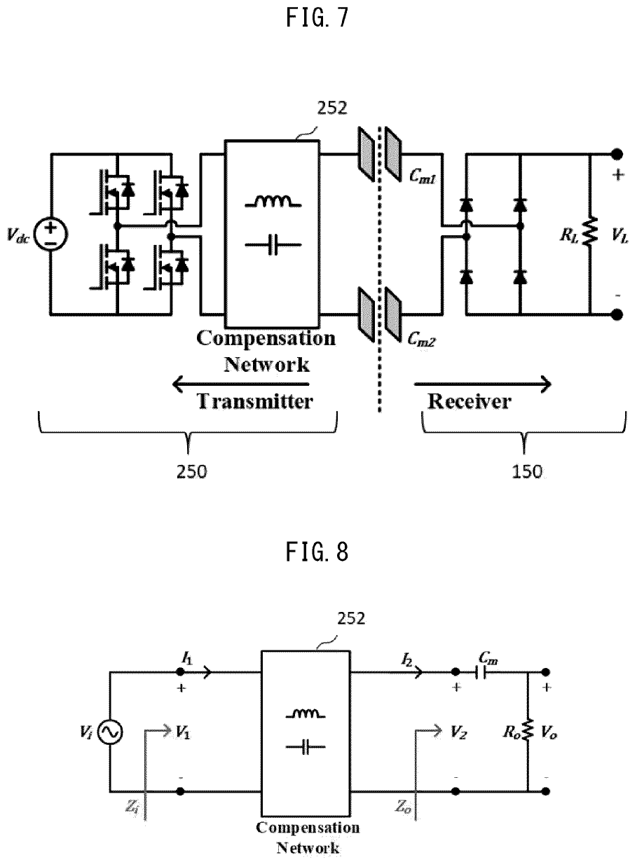

FIG. 7 is a conceptual diagram illustrating a power transfer device and/or system according to an exemplary embodiment of the present disclosure.

As shown in FIG. 7, a primary-side circuit 250 and a secondary-side circuit 150 having improved characteristics compared to the exemplary embodiment of FIG. 6 are shown. The primary-side circuit 250 may include a compensation circuit 252, and the secondary-side circuit 150 may not include a compensation network.

According to an exemplary embodiment of the present disclosure, the secondary-side circuit 150 may adopt a simple structure including only a rectifier circuit without including a separate compensation network. By adopting such the simplified structure, the thickness, weight, and cost of a part of the power transfer system, which is mounted on the EV 100, may be reduced.

According to an exemplary embodiment of the present disclosure, the secondary-side circuit 150 does not include a separate compensation network, but a compensation network of the primary-side circuit 250 to respond to a wide range of output voltage fluctuation and misalignment, that is, the compensation circuit 252 may be provided. Through the above-described circuit configuration, charging convenience may be remarkably improved according to an exemplary embodiment of the present disclosure.

The compensation circuit 252 may have parameter(s) determined based on a tolerance range of the capacitive coupling. The compensation circuit 252 may be implemented using passive elements such as inductor(s) and capacitor(s).

The tolerance range of variation in the capacitive coupling may be determined by at least one of a tolerance range of variation in a gap and a tolerance range of a misalignment between the first and second conductor plates.

The tolerance range of variation in the capacitive coupling may be determined based on assumption for at least one of: a maximum allowable voltage between the first conductor plate and the second conductor plate, an allowable range of a capacitance formed by the capacitive coupling, a size of the first conductor plate and the second conductor plate, a tolerance range of a variation in a gap between the first conductor plate and the second conductor plate, a tolerance range of a misalignment between the first conductor plate and the second conductor plate, or combinations thereof.

A frequency of the power input signal may be controlled based on a result of detecting the variation in the capacitive coupling.

FIG. 8 is a conceptual diagram illustrating an equivalent circuit-based analysis process for determining parameters of the compensation circuit 252 of the power transfer device according to an exemplary embodiment of the present disclosure.

A fundamental harmonic equivalent circuit-based analysis process may be performed to derive a condition that is controllable so that an exemplary embodiment of the present disclosure can achieve a Zero Phase Angle (ZPA) operation even under coupling variation. The ZPA operation may mean operating under a condition that the input voltage/current or output voltage/current is in-phase.

In addition, the equivalent circuit-based analysis process may be performed to derive a condition for minimizing an apparent power rating (i.e., VA rating) and improving power transfer capability. An exemplary embodiment of the present disclosure implemented through this process may minimize the volume and weight of the secondary-side circuit 150.

The parameters of the compensation circuit 252 may be designed to achieve a ZPA condition. When operating under the ZPA condition, reactive power may be canceled and high efficiency may be achieved. Additionally or alternatively, the parameter(s) of the compensation circuit 252 may be designed to achieve a constant-voltage (CV) or constant-current (CC) output. Additionally or alternatively, the parameters of the compensation circuit 252 may be determined such that a single-side compensated capacitive power transfer (CPT) system is implemented.

The coupling variation may occur due to a variation in a gap between the conductive plates and a misalignment of couplers. The output power of the CPT system may be sensitive to the coupling variation. Therefore, a compensation network considering the coupling variation is required.

The parameters of the compensation circuit 252 may be determined using an equivalent circuit analysis technique derived under the condition that a compensation operation corresponding to the tolerance range of variation in the capacitive coupling is entirely performed by the primary-side circuit. That is, an equivalent circuit analysis technique may be used to implement a power transfer device that is tolerant of the coupling variation without including a circuit in the secondary-side circuit 150 that performs compensation operations corresponding to the tolerance range of variation in the capacitive coupling.

In order to use the equivalent circuit analysis technique, when an output AC voltage of an inverter at the front of the compensation circuit 252 in the primary-side circuit 250 of FIG. 7 is an input voltage Vi of the compensation circuit 252, an input impedance may be expressed as Zi. When an output voltage of the compensation circuit 252 is Vo, an output impedance of a 2-port network may be expressed as Zo.

Using a Fundamental Harmonic Approximation (FHA) model, a relationship between Vdc of FIG. 7 and Vi of FIG. 8 and a relationship between a load resistance RL of FIG. 7 and am output resistance Ro of FIG. 8 may be expressed as in Equation 1 below.

$$\\ \begin{matrix}{V}_{i} ( t ) = \frac{4}{π} {V}_{dc} sin ( 2 π {f}_{sw} t ) & [ Equation 1 ]\end{matrix}$$

$$\\ {R}_{o} = \frac{8}{{π}^{2}} {R}_{L}$$

15

Here, π is a ratio of a circumference of a circle to its diameter, t is time, and fsw is an operating frequency of the AC signal Vi.

In addition, the capacitances Cₘ₁ and Cₘ₂ between the conductive plates of FIG. 7 may be modeled as Cₘ of FIG. 8, and a relational expression may be expressed as Equation 2 below.

$${C}_{m} = \frac{{C}_{m 1} {C}_{m 2}}{{C}_{m 1} + {C}_{m 2}} \qquad [ Equation 2 ]$$

In this case, it is assumed that a small cross capacitance is ignorable. The coupling variation may be equivalently considered as a variation of Cₘ.

The relationship between input port parameters V₁ and I₁ and output port parameters V₂ and I₂ of the compensation circuit 252 may be expressed as Equation 3 below as a Z-parameter model.

$$[ \begin{matrix}{V}_{1} \\ {V}_{2}\end{matrix} ] = [ \begin{matrix}{jX}_{11} & {jX}_{12} \\ {jX}_{21} & {jX}_{22}\end{matrix} ] [ \begin{matrix}{I}_{1} \\ - {I}_{2}\end{matrix} ] . \qquad [ Equation 3 ]$$

Here, j is an imaginary unit, and X₁₁, X₁₂, X₂₁, and X₂₂ are elements constituting Z-parameters. Due to the reversibility of the network composed of passive elements, a relationship of X₁₂=X₂₁ may be established.

The design process for determining the parameters of the compensation circuit 252 may be interpreted as a process for determining X₁₁, X₁₂, and X₂₂, and a parameter set that meets a condition for achieving a target output characteristic of the CPT system may be derived.

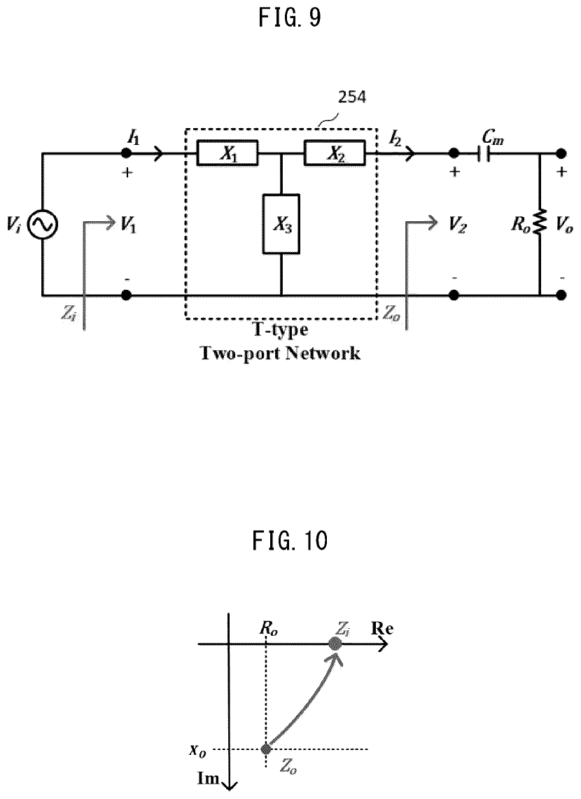

FIG. 9 is a conceptual diagram illustrating a T-type 2-port network equivalent circuit-based analysis process for determining parameters of the compensation circuit 252 of the power transfer device according to an exemplary embodiment of the present disclosure.

The parameters of the compensation circuit 252 may be determined using a T-type two-port equivalent circuit 254 analysis technique for the compensation circuit 252. A T-model may be calculated and implemented once the design parameters X₁₁, X₁₂, and X₂₂ and an operating frequency are determined. A relationship between the Z-parameters and the T-model parameters X₁, X₂, and X₃ may be expressed as in Equation 4 below.

$$\{ \begin{matrix}{X}_{1} = {X}_{11} - {X}_{12} \\ {X}_{2} = {X}_{22} - {X}_{12} \\ {X}_{3} = {X}_{12}\end{matrix} \qquad [ Equation 4 ]$$

The input impedance Zi may be represented by a real part Ri and an imaginary part Xi as shown in Equation 5 below.

$${Z}_{i} = \frac{{I}_{1}}{{V}_{1}} = {R}_{i} + j {X}_{i} = j {X}_{11} + \frac{{X}_{12}^{2}}{{Z}_{o} + {jX}_{22}} \qquad [ Equation 5 ]$$

Combining Equation 3 and Equation 5, a relationship between Ri, Xi, Ro, and Xo may be expressed as in Equation 6 below.

$${R}_{i} = \frac{{X}_{12}^{2} {R}_{o}}{{R}_{l}^{2} + {( {X}_{o} + {X}_{22} )}^{2}} . \\ {X}_{i} = {X}_{11} - \frac{{X}_{12}^{2} ( {X}_{o} + {X}_{22} )}{{R}_{o}^{2} + {( {X}_{o} + {X}_{22} )}^{2}} . \qquad [ Equation 6 ]$$

The output impedance Zo may be expressed as in Equation 7 below.

$${Z}_{o} = \frac{{I}_{2}}{{V}_{2}} = {R}_{o} + {jX}_{o} . \\ {X}_{o} = - \frac{1}{2 π {f}_{sw} {C}_{m}} . \qquad [ Equation 7 ]$$

Through the process up to this point, an output current waveform may be determined, and the coupling variation may be modeled through a variation of a parameter Xo (i.e., reactance). The minimum and maximum values of the output impedance may be determined based on the design and misalignment of the couplers (conductive plates).

The input impedance may be assumed to be purely resistive, thereby achieving the ZPA condition and power requirements.

FIG. 10 is a diagram illustrating a single frequency-based impedance analysis process for determining parameters of the compensation circuit of the power transfer device according to an exemplary embodiment of the present disclosure.

As shown in FIG. 10, the coupling variation may be modeled through a single frequency-based impedance analysis. This process may correspond to a process of designing the compensation network to change a varying load impedance into a fixed input impedance. Alternatively, it may correspond to a process of designing an impedance compression network.

When a single input frequency is given, the design parameters X₁₁, X₁₂, and X₂₂ may be expressed as in Equation 8 below. The design parameters X₁₁, X₁₂, and X₂₂ may be selected to convert the output impedance to a resistive input impedance Zi which is a preselected design target.

$$\{ \begin{matrix}{X}_{11} = {X}_{i} + m {R}_{i} \\ {X}_{22} = - {X}_{o} + m {R}_{o} \\ {X}_{12} = \sqrt{( 1 + {m}^{2} ) {R}_{o} {R}_{i}}\end{matrix} \qquad [ Equation 8 ]$$

In this case, m is an arbitrary real number and may indicate a design degree of freedom (DOF). When the compensation network is designed assuming a single frequency, the output impedance may vary widely as shown in FIG. 10.

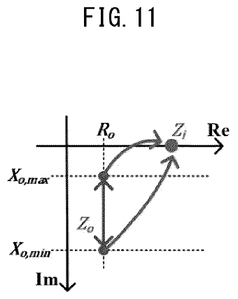

FIG. 11 is a diagram illustrating a 2-frequency based impedance analysis process for determining parameters of the compensation circuit of the power transfer device according to an exemplary embodiment of the present disclosure.

The parameters of the compensation circuit may be determined using an equivalent circuit analysis technique assuming a plurality of operating frequency candidate group for the compensation circuit.

Two endpoints of a variation range of the output impedance may be given as (Ro, Xo,max) and (Ro, Xo,min). The design parameters may be selected such that both the endpoints respond to the same input impedance Zi. An additional DOF may be obtained by shifting the operating frequency.

FIG. 11 shows a process of selecting design parameters so that two endpoints within the allowable range of variation in the output impedance that may appear due to the coupling variation are converted into the same resistive input impedance Zi.

The design process of the compensation circuit 252 of FIGS. 7 to 11 may be summarized as follows.

First, the target input impedance Zi may be selected.

A capacitive coupling model parameter Cm and a range of the operating frequency fsw may be determined.

Two DOF values m_{A} and m_{B} may be selected.

Values of the passive components of the compensation circuit 252 may be determined.

The target input impedance Zi may be selected to satisfy the following condition.

The ZPA condition needs to be satisfied. The ZPA condition may achieve high efficiency by offsetting the reactive power.

Since the target input impedance Zi should be purely resistive, Xi=0 may be assumed.

For a fixed resistive load, a constant output power and load voltage V_{L} may be considered to be achieved.

The condition of Equation 9 below may be derived under the fundamental frequency approximation (FHA) and lossless assumption.

$${R}_{i} = {( \frac{{V}_{d c}}{{V}_{L}} )}^{2} {R}_{o} = \frac{{R}_{o}}{{G}_{v}^{2}} \qquad [ Equation 9 ]$$

A relationship with the resistance component Ri of the target input impedance may be expressed by considering the resistance component Ro of the output impedance and a voltage gain Gv.

A process of determining DOF values may be performed as follows.

It may be assumed that the range of the operating frequency fsw is [f_{A}, f_{B}], which may be configured considering a variation of 5-10% under practical industrial applications.

The key idea of the 2-frequency design is to match the endpoints of the variation of the impedance to the minimum and maximum frequencies, respectively. This matching process may be expressed by Equation 10.

Z_{o,A}(Rₒ+jX_{o,max})

Z_{o,B}(Rₒ+jX_{o,min}) [Equation 10]

The design parameters X₁₁, X₁₂, and X₂₂ corresponding to each of the frequency endpoints (i.e., f_{A} and f_{B}) may be expressed as in Equation 11 below.

$$\{ \begin{matrix}{X}_{11 , N} = {m}_{N} {R}_{i} \\ {X}_{22 , N} = - {X}_{o , N} + {m}_{N} {R}_{o} \\ {X}_{12 , N} = \sqrt{( 1 + {m}_{N}^{2} ) {R}_{o} {R}_{i}}\end{matrix} \qquad [ Equation 11 ]$$

In this case, N means A or B, and is an index corresponding to each frequency endpoint. The real number mN is an arbitrary real number corresponding to each frequency index and means a DOF. The DOF corresponding to each frequency index may be expressed as in Equation 12 below.

$${m}_{N} = - \frac{{X}_{o , N}}{{R}_{o}} ( N = A or B ) \qquad [ Equation 12 ]$$

Depending on the final design parameters, a DOF considering each frequency index may be determined so that the output impedance Zo corresponds to the preset target input impedance Zi. The DOFs corresponding to the respective indices A and B may be determined so that the design parameters of the frequency index A coincide with the design parameters of the frequency index B. In this case, the DOFs may be determined in consideration of Equation 13. For example, the condition of Xo,max of FIG. 11 may correspond to the index A (i.e., Xo,A=Xo,max), and the condition of Xo,min of FIG. 11 may correspond to the index B (i.e., Xo,B=Xo,min).

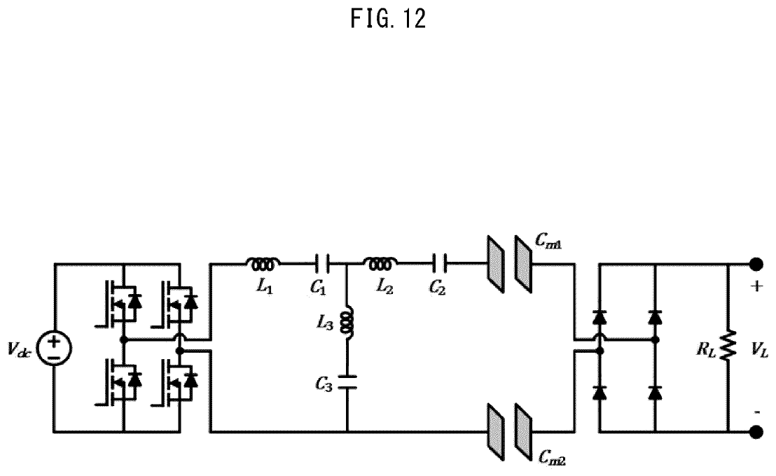

FIG. 12 is a diagram illustrating the primary-side circuit of the power transfer device including the compensation circuit whose parameters are determined according to an exemplary embodiment of the present disclosure.

As shown in FIG. 12, an embodiment in which T-shaped parameters are implemented with passive elements of L and C is illustrated. These parameters may be derived through the design process described above, and may be expressed by Equation 13.

$$\{ \begin{matrix}{L}_{k} = \frac{2 π {f}_{A} {X}_{k , A} - 2 π {f}_{B} {X}_{k , B}}{{( 2 π {f}_{A} )}^{2} - {( 2 π {f}_{B} )}^{2}} \\ {C}_{k} = \frac{1}{{( 2 π {f}_{A} )}^{2} {L}_{k} - 2 π {f}_{A} {X}_{k , A}}\end{matrix} ( k = 1 , 2 o r 3 ) \qquad [ Equation 13 ]$$

In this case, k may be an index according to a position of the design parameter, and k may be 1, 2, or 3 in the T-shaped parameters of FIG. 12.

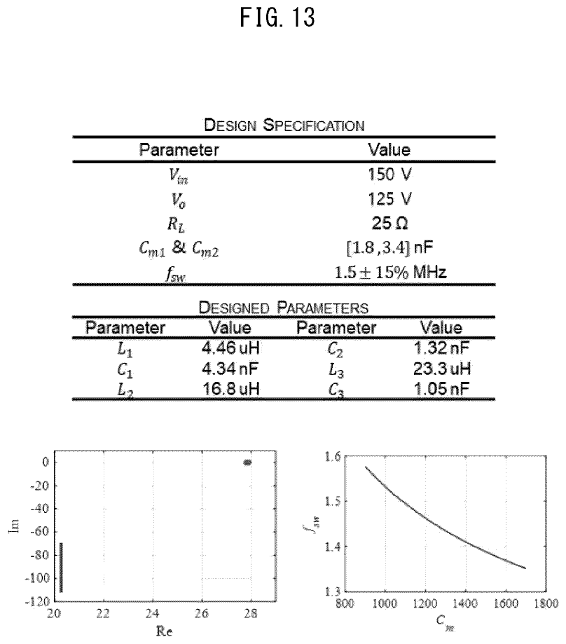

FIG. 13 is a diagram illustrating a parameter determination process of the primary-side compensation circuit of the power transfer device according to an exemplary embodiment of the present disclosure.

As shown in FIG. 13, a case in which the operating frequency has a variation range of 15% may be considered. The size of the input voltage, the size of the output voltage, the load resistance, and the target of the capacitive coupling may be determined and given as a design specification.

An input impedance resistance component Ri=28 [ohm] may be derived by Equation 9 above. mA=2.68 and mB=6.84 may be derived as DOF values by Equation 12 above.

Through the above-described process, L and C parameters of the 1,2,3 topology may be derived.

FIG. 13 shows a correspondence relationship between a variation in operating frequency according to the coupling variation and input/output impedances corresponding thereto.

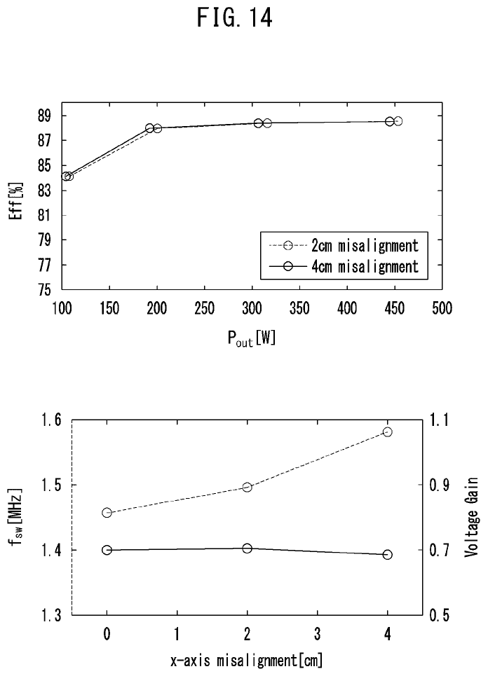

FIG. 14 is a diagram illustrating a parameter determination process of the primary-side compensation circuit of the power transfer device according to an exemplary embodiment of the present disclosure.

As shown in FIG. 14, measurement results of a variation in efficiency of an output power Pout and a variation in operating frequency fsw when a misalignment on x-y coordinates between the conductive plates is 2 cm and 4 cm are shown, respectively. In this case, constant efficiency and constant voltage/constant current (CV/CC) conditions may be achieved by controlling the operating frequency to vary within a range based on a misalignment on the x-axis.

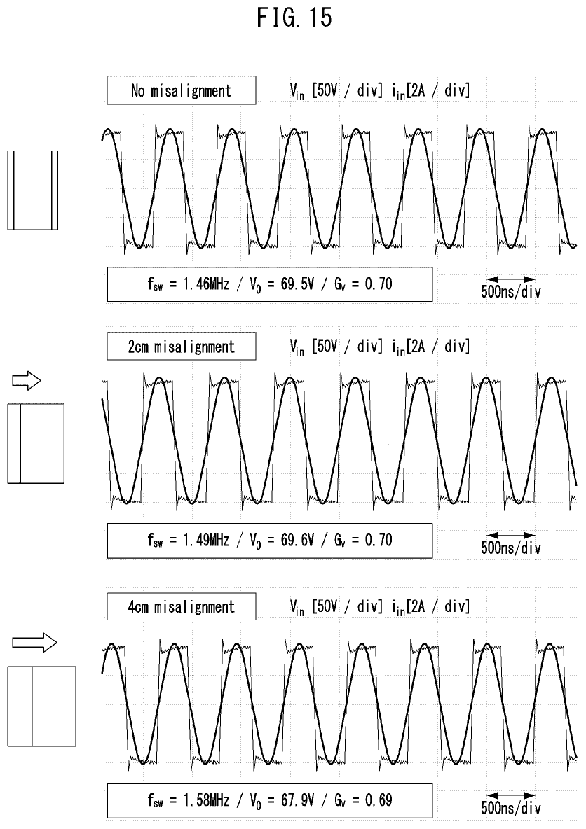

FIG. 15 is a diagram illustrating an operation method of the power transfer device tolerant of coupling variation according to an exemplary embodiment of the present disclosure.

As shown in FIG. 15, an operating frequency of 1.46 MHz, an output voltage of 69.5 V, and a gain of 0.70 may be achieved through experiments under the assumption of no misalignment. An operating frequency of 1.49 MHz, an output voltage of 69.6 V, and a gain of 0.70 may be achieved through experiments under the assumption of a misalignment of 2 cm. An operating frequency of 1.58 MHz, an output voltage of 67.9 V, and a gain of 0.69 may be achieved through experiments under the assumption of a misalignment of 4 cm.

FIGS. 7 to 15 illustrate the CPT system designed in consideration of coupling variation due to misalignment or a variation in gap between conductive plates and the power transfer device within the CPT system.

Similarly to the case of FIG. 15, in order to obtain optimal operations (high efficiency, constant voltage, constant current) that are tolerant of coupling variation, a process of controlling the operating frequency to be varied in consideration of the coupling variation may be proposed according to an exemplary embodiment of the present disclosure.

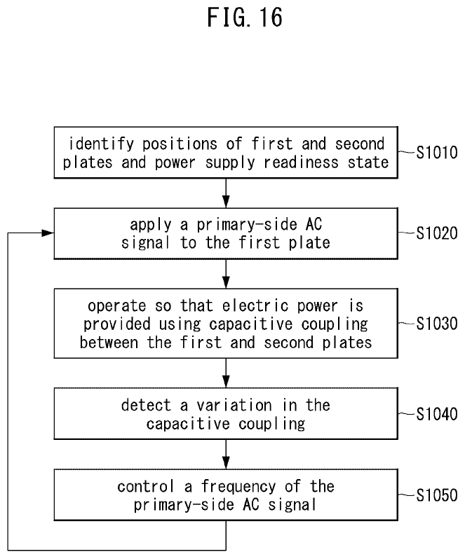

FIG. 16 is an operational flowchart illustrating an operation method of the power transfer device tolerant of coupling variation according to an exemplary embodiment of the present disclosure.

As shown in FIG. 16, as a preparation step for WPT, a positions of the first conductor plate on the primary side, a position of the second conductor plate on the secondary side, and a power supply readiness state may be identified (S1010). This process may be executed by the power transfer device disposed in the EVSE, or may be performed by communication and sharing of sensing information between the EVSE and the EV 100.

As a WPT initiation step, a primary-side AC signal may be applied to the first conductor plate on the primary side (S1020).

As a WPT step, an operation may be performed to supply power using capacitive coupling between the first conductor plate and the second conductor plate (S1030). This process may be performed mainly by the operation of the power transfer device disposed in the EVSE. However, each of the EVSE or the EV 100 may operate in order to obtain information necessary for auxiliary control, and communication and sensing information may be shared between the EVSE and the EV 100.

As part of a control process for WPT, a variation in capacitive coupling between the first conductor plate and the second conductor plate may be detected (S1040). This process may be performed by the operation of circuits subordinate to the EVSE or the EV 100, respectively, or may be performed by communication and sharing of sensing information between the circuits subordinate to the EVSE and the EV 100.

As part of a control process for WPT, a frequency of a primary-side AC signal may be controlled based on the coupling variation (S1050). This process may be performed mainly by the operation of the power transfer device disposed in the EVSE. However, each of the EVSE or the EV 100 may operate in order to obtain information necessary for auxiliary control, and communication and sensing information may be shared between the EVSE and the EV 100.

In the step S1050, the frequency of the primary-side AC signal may be controlled within a target range. The step S1040 may include a step of measuring state variable(s) of at least one of the primary-side AC signal and a secondary-side AC signal. In this case, the state variable(s) may include at least one of voltage, current, frequency, phase, power, and efficiency.

The coupling variation may be formed by at least one of a misalignment or a variation in gap between the first conductor plate and the second conductor plate.

The process of controlling the operating frequency by measuring the state variable(s) may be implemented using at least one of known feedback control techniques. The feedback control techniques may include PI, PD, PID control techniques, and the like. The feedback control techniques may also include known closed-loop control techniques.

The process of controlling the operating frequency based on the measurement of the state variable(s) may be implemented using known voltage measurement technology, current measurement technology, or power measurement technology. Utilization of these known technologies constitutes a part of the power transfer method according to exemplary embodiments of the present disclosure, and thus the scope of rights of the power transfer method of the present disclosure should not be construed as being reduced or limited.

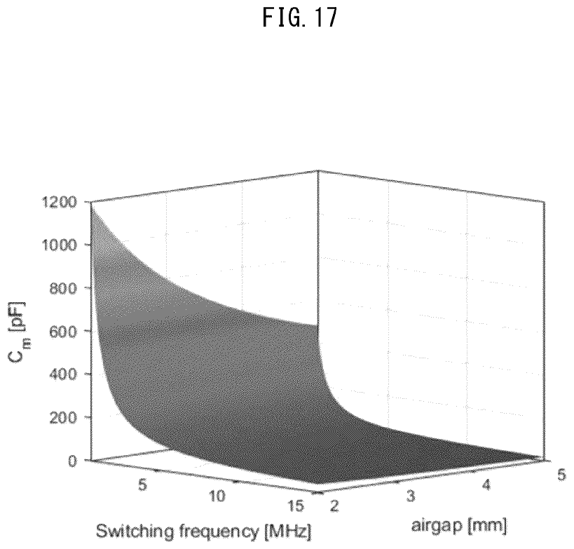

FIG. 17 is a diagram illustrating a process of determining a capacitance in consideration of a breakdown voltage related to a process of determining parameters of the primary-side compensation circuit of the power transfer device according to an exemplary embodiment of the present disclosure.

In the process of designing the sizes of the primary-side and secondary-side conductive plates, a target capacitance Cm may be designed first.

The target capacitance may be designed such that a voltage difference between the conductive plates is less than a certain voltage Vplate so that an arcing in air does not occur.

In this case, a voltage at which the arcing phenomenon occurs may be expressed as a breakdown voltage.

As shown in FIG. 17, the target capacitance Cm may be simulated under a condition that a voltage equal to or less than the breakdown voltage is formed between the conductive plates by a switching frequency and a gap.

Here, the arcing phenomenon may generate a short circuit in the air, and may cause a drift between a system resonance frequency and the operating frequency, which may cause system failure and component damage.

In this case, when an AC induced on both sides of the conductive plate is Iac and the maximum allowable voltage is Vplate, a stress received by each conductive plate is proportional to Vₚₗₐₜₑ/2, which is expressed by a relational expression of Vplate=Iac/[2*(2 πcfswCₘ)].

The target capacitance Cm obtained therefrom may be derived from an equation of Cm=Iac/(4 πfsw*Vplate).

The breakdown voltage according to the AC voltage may be derived as follows.

When the maximum allowable electric field Ebr=2.1 MV/m is given, it may be derived as Vplate_max=Ebr*d. In this case, d means the gap between the conductive plates.

C_{m_min} may be derived by Iac_max/(4 πfsw*Ebr*d).

That is, an allowable range of the maximum and minimum values of Cₘ may be determined by analyzing the stress and breakdown voltage.

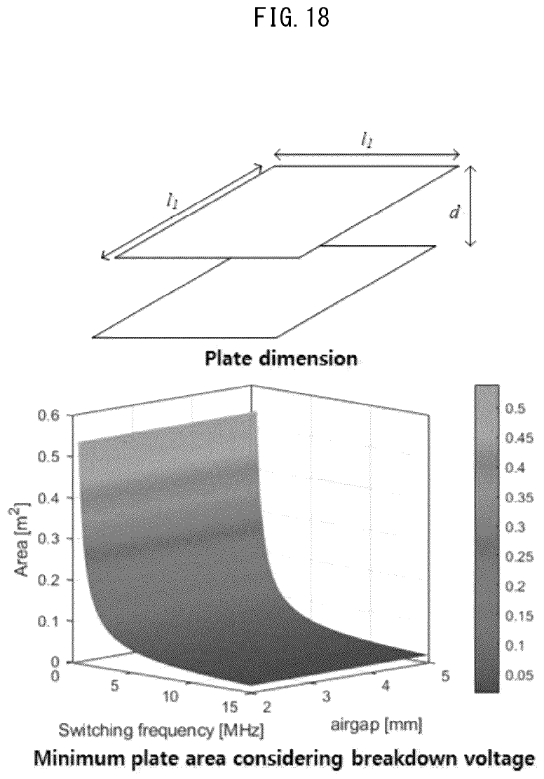

FIG. 18 is a diagram illustrating a process of determining the size of the conductor plate related to a process of determining capacitance according to an exemplary embodiment of the present disclosure.

The process of determining the size of the conductive plate to obtain the desired Cm is as follows.

When assuming that the size of gap is small enough compared to the size of the conductor plate to ignore a fringing effect, a relational expression of Cplate=ϵ0*1₁\hat{ }2/d may be obtained. Here, ϵ0 is a permittivity of vacuum, and 1₁ is the length of the x-axis and y-axis of the plate shown in FIG. 18. As shown in FIG. 18, d represents the gap.

Since the relational expression Cplate=2*Cₘ holds, a plate area A satisfies a relation A=1₁\hat{ }2=(Cplate*d)/ϵ0.

When considering the size and shape of the flat plate, modeling considering the fringing effect may satisfy Equation 14 below when using numerical calculation.

$${c}_{plate} = {ε}_{0} \frac{{l}_{1}^{2}}{d} [ 1 + 2.343 \times {( \frac{d}{{l}_{1}} )}^{0.891} ] \qquad [ Equation 14 ]$$

FIG. 18 shows a result of calculating the area of the conductive plate that satisfies the target capacitance Cₘ according to a switching frequency and a gap.

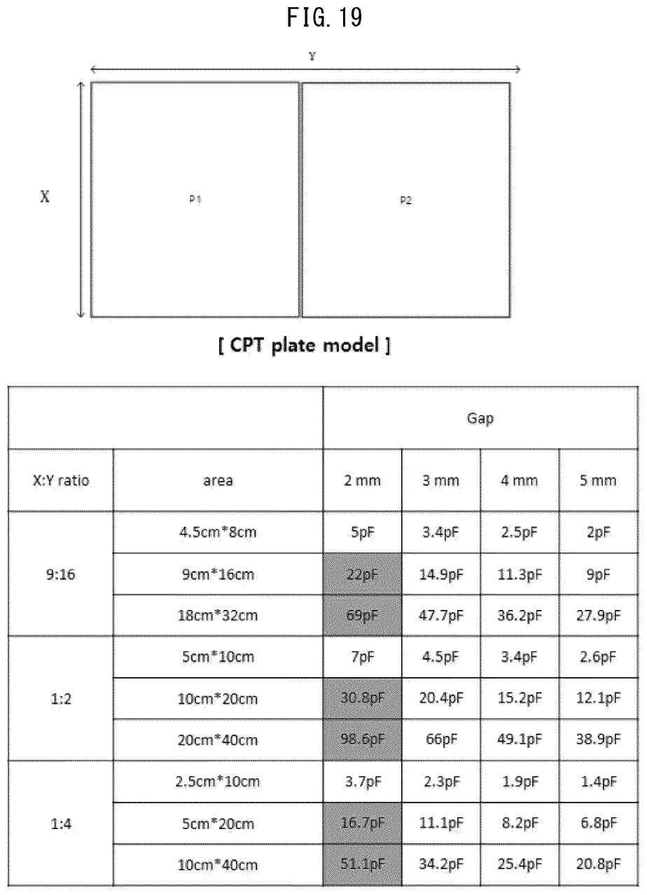

FIG. 19 is a diagram illustrating a relationship between a size of a conductor plate and a capacitance related to a process of determining parameters of the power transfer device according to an exemplary embodiment of the present disclosure.

FIG. 19 shows an exemplary embodiment in which a result of calculating a size of a conductive plate to obtain a desired capacitance Cₘ is verified through FEM simulation.

Various areas may be configured to correspond to various X-Y ratios, and the capacitance Cₘ may be calculated under assumption of a gap range of 2 mm to 5 mm.

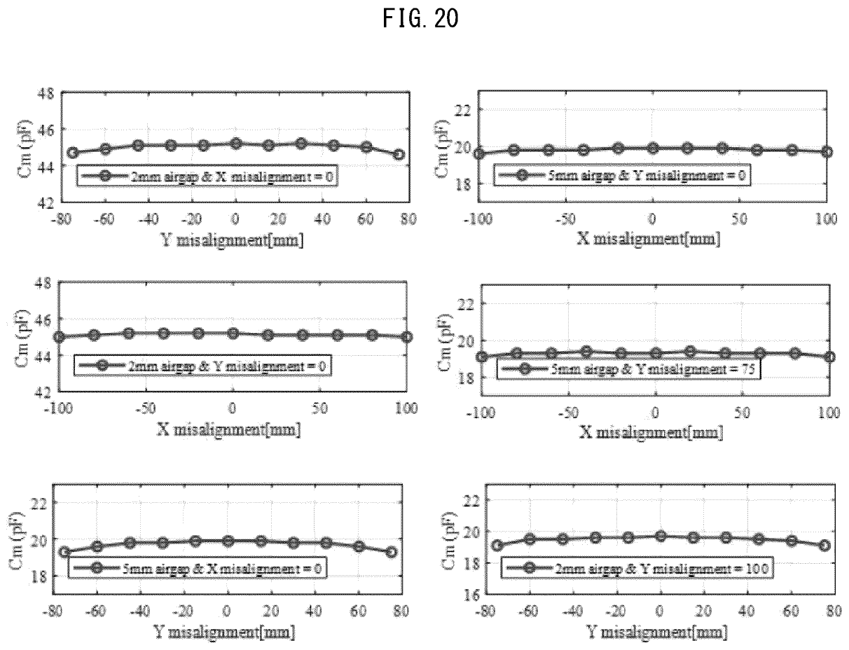

FIG. 20 is a diagram illustrating a relationship between a size of a conductor plate, coupling variation, and capacitance related to a process of determining parameters of the power transfer device according to an exemplary embodiment of the present disclosure.

As shown in FIG. 20, results of calculating Cₘ assuming a gap of 2 mm or 5 mm under various assumptions of misalignment in the X-axis direction and Y-axis direction are shown for comparison.

In the exemplary embodiment of FIG. 20, simulation results are shown in a state in which the conductive flat plate is assumed to have an asymmetric structure. For example, it may be assumed that the flat plate of the receiver is 135*136 mm and the flat plate of the transmitter is 300*350 mm.

Even at the maximum misalignment, it can be seen that the mutual capacitance value is maintained at 45 pF for the 2 mm gap and 19 pF for the 5 mm gap.

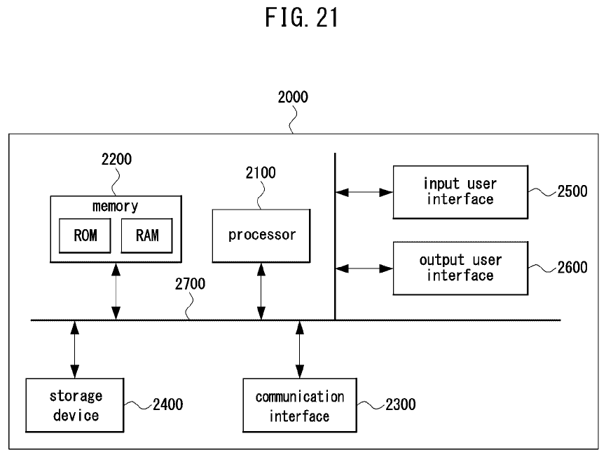

FIG. 21 is a conceptual diagram illustrating an example of a generalized wireless power transfer apparatus, wireless power transfer system, or computing system for controlling wireless power transfer procedure, which is capable of performing at least part of the methods of FIGS. 1 to 20.

Although omitted in the drawings in the embodiments of FIGS. 1 to 20, a processor and a memory are electronically connected to each component, and the operation of each component can be controlled or managed by the processor.

At least some operations and/or procedures of the method of operating a power transfer device robust to coupling fluctuations according to an embodiment of the present disclosure may be performed by the computing system 2000 of FIG. 21.

Referring to FIG. 21, the computing system 2000 according to an embodiment of the present disclosure may include a processor 2100, a memory 2200, a communication interface 2300, a storage device 2400, an input interface 2500, an output interface 2600 and a bus 2700.

The computing system 2000 according to an embodiment of the present disclosure may include at least one processor 2100, and the memory 2200 storing instructions to instruct the at least one processor 2100 to perform at least one operation. At least some operations of the method according to an embodiment of the present disclosure may be performed by loading the instructions from the memory 2200 and executing the instructions by the at least one processor 2100.

The processor 2100 may be understood to mean a central processing unit (CPU), a graphics processing unit (GPU), or a dedicated processor configured to perform methods according to embodiments of the present disclosure.

Each of the memory 2200 and the storage device 2400 may include at least one of a volatile storage medium or a nonvolatile storage medium. For example, the memory 2200 may include at least one of a read-only memory (ROM) or a random access memory (RAM).

The computing system 2000 may include the communication interface 2300 that performs communication through a wireless network.

The computing system 2000 may further include the storage device 2400, the input interface 2500, the output interface 2600, and the like.

The components of the computing system 2000 may be connected to one another via the bus 2700 to communicate with one another.

Examples of the computing system 2000 of the present disclosure may include a desktop computer, a laptop computer, a notebook, a smart phone, a tablet PC, a mobile phone, a smart watch, smart glasses, an e-book reader, a portable multimedia player (PMP), a portable game console, a navigation device, a digital camera, a digital multimedia broadcasting (DMB) player, a digital audio recorder, a digital audio player, a digital video recorder, a digital video player, a personal digital assistant (PDA), and the like, which are capable of establishing communication.

Here, the at least one instruction (or command) may include: a command for identifying a position of the first conductor plate on the primary side and a position of the second conductor plate on the secondary side and a power supply readiness (i.e., preparation) state as a preparation step for WPT, a command for applying a primary-side AC signal to the first conductor plate on the primary side as an initiation step for WPT, a command for supplying power by using capacitive coupling between the first conductor plate and the second conductor plate as a step of WPT, a command for detecting a variation in the capacitive coupling between the first and second conductor plates as a part of a control process for WPT, and a command for controlling a frequency of the primary-side AC signal based on the variation in the capacitive coupling as a part of the control process for WPT.

In addition, the at least one instruction (or command) may further include a command for controlling the frequency of the primary-side AC signal within a target range, and a command for measuring state variable(s) of at least one of the primary-side AC signal and the secondary-side AC signal.

According to an exemplary embodiment of the present disclosure, capacitive WPT using conductor plates instead of coil structure pads is used, thereby reducing the thickness, weight, and cost of a vehicle-mounted part compared to the conventional inductive WPT system.

According to an exemplary embodiment of the present disclosure, provided are a power transfer system, device, and operation methods thereof having constant output voltage and power and high efficiency without implementing a separate matching network in a reception unit for WPT.

According to an exemplary embodiment of the present disclosure, provided are a power transfer system, device, and operation methods thereof that can achieve additional weight and cost reduction effects by not implementing a separate matching network in a reception unit for WPT.

According to an exemplary embodiment of the present disclosure, provided are a power transfer system, device, and operation methods thereof that can increase convenience of charging with a system having tolerant characteristics against output voltage fluctuations for loads and misalignment between transmission/reception pads.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A power transfer system comprising:
an electric vehicle supply equipment (EVSE) for providing electric power to an electric vehicle (EV) and an electric power reception device mounted in the EV;
a first conductor plate electrically connected to a primary-side circuit of the EVSE;
a compensation circuit for transferring a power input signal of the EVSE to the first conductor plate;
a second conductor plate disposed in the EV and connected to the electric power reception device; and
a secondary-side circuit for transferring a power signal received by the second conductor plate to a load,
wherein the electric power is transferred from the EVSE to the EV by capacitive coupling between the first conductor plate and the second conductor plate.

2. The power transfer system according to claim 1, wherein the compensation circuit has parameters determined based on a tolerance range of a variation in the capacitive coupling.

3. The power transfer system according to claim 2, wherein the parameters of the compensation circuit are determined using an equivalent circuit analysis technique derived under a condition that a compensation operation corresponding to the tolerance range of the variation in the capacitive coupling is entirely performed by the primary-side circuit.

4. The power transfer system according to claim 3, wherein the parameters of the compensation circuit are determined using a T-type 2-port equivalent circuit analysis technique for the compensation circuit.

5. The power transfer system according to claim 3, wherein the parameters of the compensation circuit are determined using an equivalent circuit analysis technique assuming a plurality of operating frequency candidate group for the compensation circuit.

6. The power transfer system according to claim 2, wherein the tolerance range of the variation in the capacitive coupling is determined based on at least one of a tolerance range of a variation in a gap and a tolerance range of a misalignment between the first conductor plate and the second conductor plate.

7. The power transfer system according to claim 2, wherein the tolerance range of the variation in the capacitive coupling is determined based on assumption for at least one of:
a maximum allowable voltage between the first conductor plate and the second conductor plate;
an allowable range of a capacitance formed by the capacitive coupling;
a size of the first conductor plate and the second conductor plate;
a tolerance range of a variation in a gap between the first conductor plate and the second conductor plate; or
a tolerance range of a misalignment between the first conductor plate and the second conductor plate.

8. The power transfer system according to claim 1, wherein an operating range of a frequency of the power input signal is controlled based on a result of detecting a variation in the capacitive coupling.

9. A power transfer device disposed in an electric vehicle supply equipment (EVSE) for providing electric power to an electric vehicle (EV), the power transfer device comprising:
a first conductor plate; and
a compensation circuit for transferring a power input signal of the EVSE to the first conductor plate,
wherein the electric power is transferred from the EVSE to the EV by capacitive coupling between the first conductor plate and a second conductor plate electrically connected to a secondary-side circuit of the EV.

10. An electric vehicle comprising an electric power reception device for receiving electric power from the power transfer device of claim 9.

11. The power transfer device according to claim 9, wherein the compensation circuit has parameters determined based on a tolerance range of a variation in the capacitive coupling, and wherein the parameters are determined using an equivalent circuit analysis technique derived under a condition that a compensation operation corresponding to the tolerance range of the variation in the capacitive coupling is entirely performed by the compensation circuit.

12. The power transfer device according to claim 11, wherein the parameters of the compensation circuit are determined using a T-type 2-port equivalent circuit analysis technique for the compensation circuit.

13. The power transfer device according to claim 11, wherein the parameters of the compensation circuit are determined using an equivalent circuit analysis technique assuming a plurality of operating frequency candidate group for the compensation circuit.

14. The power transfer device according to claim 10, wherein the tolerance range of the variation in the capacitive coupling is determined by at least one of a tolerance range of a variation in a gap and a tolerance range of a misalignment between the first conductor plate and the second conductor plate.

15. The power transfer device according to claim 10, wherein the tolerance range of the variation in the capacitive coupling is determined based on assumption for at least one of:
a maximum allowable voltage between the first conductor plate and the second conductor plate;
an allowable range of a capacitance formed by the capacitive coupling;
a size of the first conductor plate and the second conductor plate;
a tolerance range of a variation in a gap between the first conductor plate and the second conductor plate; or
a tolerance range of a misalignment between the first conductor plate and the second conductor plate.

16. The power transfer device according to claim 9, wherein an operating range of a frequency of the power input signal is controlled based on a result of detecting a variation in the capacitive coupling.

17. An operation method of a power transfer device, the operation method comprising:
disposing the power transfer device in an electric vehicle supply equipment (EVSE) for providing electrical power to an electric vehicle (EV);
operating the power transfer device so that a secondary-side alternating current (AC) signal is induced on a second conductor plate of the power transfer device connected to the EV based on a variation in an electric field due to a primary-side AC signal applied to a first conductor plate of the power transfer device connected to the EVSE;
detecting a variation in capacitive coupling between the first conductor plate and the second conductor plate; and
controlling a frequency of the primary-side AC signal based on the variation in the capacitance coupling.

18. The operation method according to claim 17, wherein in the controlling of the frequency of the primary-side AC signal, the frequency of the primary-side AC signal is controlled within a target range.

19. The operation method according to claim 17, wherein the detecting of the variation in the capacitive coupling comprises: measuring state variable(s) of at least one of the primary-side AC signal and the secondary-side AC signal, wherein the state variable(s) includes at least one of voltage, current, frequency, phase, power, and efficiency.

20. The operation method according to claim 17, wherein the variation in the capacitive coupling is foimed by at least one of a variation in a gap or a misalignment between the first conductor plate and the second conductor plate.
